(19) United States
(12) Patent Application Publication
(10) Pub. No.: US 2005/0006504 A1
(43) Pub. Date: Jan. 13, 2005

(54) Waste treatment apparatus

(76) Inventor: Mark Henry Butler, Barden Ridge (AU)

Correspondence Address: RYDER IP LAW, PC;DOUGLAS J. RYDER, 3669 CONCORD ROAD, DOYLESTOWN, PA, 18901, US

(21) Appl. No.: 10/498,271

(22) PCT Filed: Dec. 11, 2002
(86) PCT No.: PCT/AU02/01674

(30) Foreign Application Priority Data
Dec. 11, 2001 (AU) PR 9551

(51) Int. Cl. B02C 19/00

(52) U.S. Cl. 241/65; 241/236

(57) ABSTRACT

Waste treatment apparatus (200) includes a hopper (201) having an inlet for receiving waste material, a first waste treatment chamber (202), a shredder mechanism (230) operative to effect a first cutting treatment of the waste material as the waste material is discharged from the hopper (201) to the first waste treatment chamber (207), a second cutting mechanism (250) within the first waste treatment (202) chamber operative to effect a second cutting treatment of the waste material before it is discharged to a second treatment chamber (203), a gate mechanism to discharge the treated waste material from the apparatus; and means for introducing steam into the first and second treatment chambers (202 and 203).

### FIELD OF THE INVENTION

The present invention relates to waste treatment apparatus such as waste treatment apparatus for use in the sterilisation of infectious or quarantined waste. However, it will be appreciated that the invention is not limited to that particular use as it will find application in treating other types of waste particularly that which requires sterilisation.

### BACKGROUND ART

Hospitals produce a large amount of infectious or quarantined waste. Generally, most hospitals have a number of infectious waste collection bins dispersed throughout the various wards and departments. These waste bins are periodically collected and removed to an off-site waste treatment facility for chemical sterilisation or high-temperature incineration of the waste, followed by sterilisation of the bin itself. This is an expensive process which suffers from many disadvantages.

One such disadvantage is the risk of environmental damage during the transport of infectious waste over public roads. In addition, the building and operation of an off-site chemical or incineration treatment centre represents a high capital cost outlay and requires expensive chemicals and/or fuels for operation.

### SUMMARY OF THE INVENTION

Accordingly to one aspect of the invention there is provided a waste treatment apparatus comprising:
(i) a hopper having an inlet for receiving waste material and an outlet for discharging the waste material;
(ii) a first waste treatment chamber having an inlet in communication with the outlet of the hopper; and an outlet;
(iii) a first cutting mechanism operative to effect a first cutting treatment of the waste material as the waste material is discharged from the hopper to the first waste treatment chamber;
(iv) a second waste treatment chamber having an inlet in communication with the outlet of the first waste treatment chamber, and an outlet;
(v) a second cutting mechanism within the first waste chamber operative to effect a second cutting treatment of the waste material before it is discharged to the second treatment chamber;
(vi) a gate mechanism at the outlet of the second waste treatment chamber operative to permit discharge of the treated waste material from the apparatus;
(vii) means for introducing steam into the first treatment chamber whilst the first cutting mechanism is in operation; and
(viii) means for introducing steam into the second treatment chamber whilst waste material is transported from the inlet of the second treatment chamber to the outlet of the second treatment chamber.

According to another aspect of the invention there is provided a gate mechanism operative to permit discharge of treated waste material from waste treatment apparatus comprising an inner gate and an outer gate and wherein the outer gate is opened and closed by an actuator and the inner gate is connected to the outer gate so that it is opened and closed by the movement of the outer gate.

According to another aspect of the invention there is provided a cutting mechanism for waste treatment apparatus comprising a pair of rotating shafts on which are mounted shredder blades, the shredder blades being arranged on each shaft so as to be in register with the blades on adjacent shafts.

### BRIEF DESCRIPTION OF THE DRAWINGS

FIG. 1 is a top plan view of a waste treatment apparatus according to one embodiment of the invention;

FIG. 2 is a simplified, side elevation view of the waste treatment apparatus shown in FIG. 1;

FIG. 3 is a simplified, front elevational view of the waste treatment apparatus shown in FIGS. 1 and 2;

FIG. 4 is a partially cross-sectioned end view of the hopper and the first cutting mechanism of the waste treatment apparatus shown in FIGS. 1 to 3;

FIG. 5 is a perspective view of the second cutting mechanism of the waste treatment apparatus shown in FIGS. 1 to 3;

FIG. 6 is a cross-sectional view of a steam inlet valve for supplying steam to the first and second chambers of the waste treatment apparatus shown in FIGS. 1 to 3;

FIG. 7 is a simplified end elevational view of the first waste treatment chamber of the waste treatment apparatus shown in FIGS. 1 to 3 showing its door in the open position;

FIG. 8 is an end view of the gate mechanism of the second waste treatment chamber of the waste treatment apparatus shown in FIGS. 1 to 3;

FIG. 9 is a partially cross-sectioned side elevational view of the gate mechanism shown in FIG. 8;

FIG. 10 is a view similar to FIG. 8 showing one half gate open;

FIG. 11 is a view similar to FIG. 10 with the second half gate and the first gate partly open;

FIG. 12 is a view similar to FIG. 11 with the second half gate and the first gate half open;

FIG. 13 is a view similar to FIG. 12 with the second half gate and the first gate fully open;

FIG. 14 is a simplified side elevational view of the bin washer of the waste treatment apparatus shown in FIGS. 1 to 3;

FIG. 15 is a simplified top plan view of a waste treatment apparatus according to a second embodiment of the invention;

FIG. 16 is a simplified side elevational view of the waste treatment apparatus shown in FIG. 15;

FIG. 17 is a front elevational view of the waste treatment apparatus shown in FIGS. 15 and 16;

FIG. 18 is a simplified front elevational view of the waste treatment apparatus shown in FIGS. 15 and 16 without the bin and the bin conveyor; and

FIG. 19 is a side elevational view of a bin washer module for the waste treatment apparatus shown in FIGS. 15 and 16.

### MODES FOR CARRYING OUT THE INVENTION

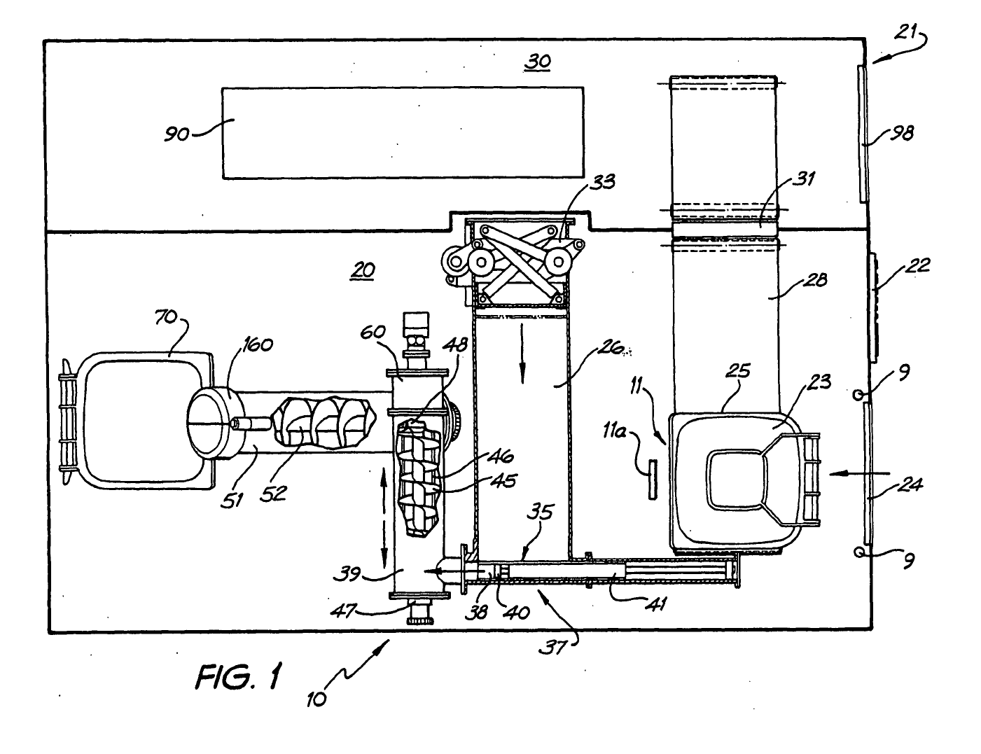

As shown in FIG. 1, a waste treatment apparatus 10 according to one embodiment of the invention includes an enclosed waste treatment module 20 and an optional enclosed bin washing module 30 both of which are contained within a main enclosure 21.

The front of the enclosure 21 incorporates a control panel 22. The apparatus 10 is controlled by, and various indications and warnings are provided on, the control panel 22.

Waste material contained in a bin 23 is introduced into the waste treatment module 20 through a vertically sliding loading door 24. When the loading door 24 is opened, a metal detection unit 13 within the apparatus 10 is activated and the bin 23, with its lid open, is checked for metal as it is wheeled into the loading position. The metal detector 13 is adapted to provide an indication of the quantity of metal contained in the bin 23. If the quantity is excessive, an indication is provided on the control panel and the bin is replaced or otherwise dealt with prior to re-initiation of the waste treatment process. The right side 25 of the bin 23 incorporates a bar code so that each bin may be individually identified by the control system.

Once in the appropriate position on the weighing platform 11, as indicated by the proximity sensor 12, various checks are conducted on the bin 23 and its contents. With the bin in position and the lid open, the bar code is detected and recorded. The bin is checked for correct fill level and weight. Warnings are given if the bin is too full or over-weight and the process will not continue until the situation is remedied.

If the outcome of the bin testing is acceptable, the control panel 22 will indicate a satisfactory outcome, allowing the operator to initiate the treatment process which begins with closing the loading door 24.

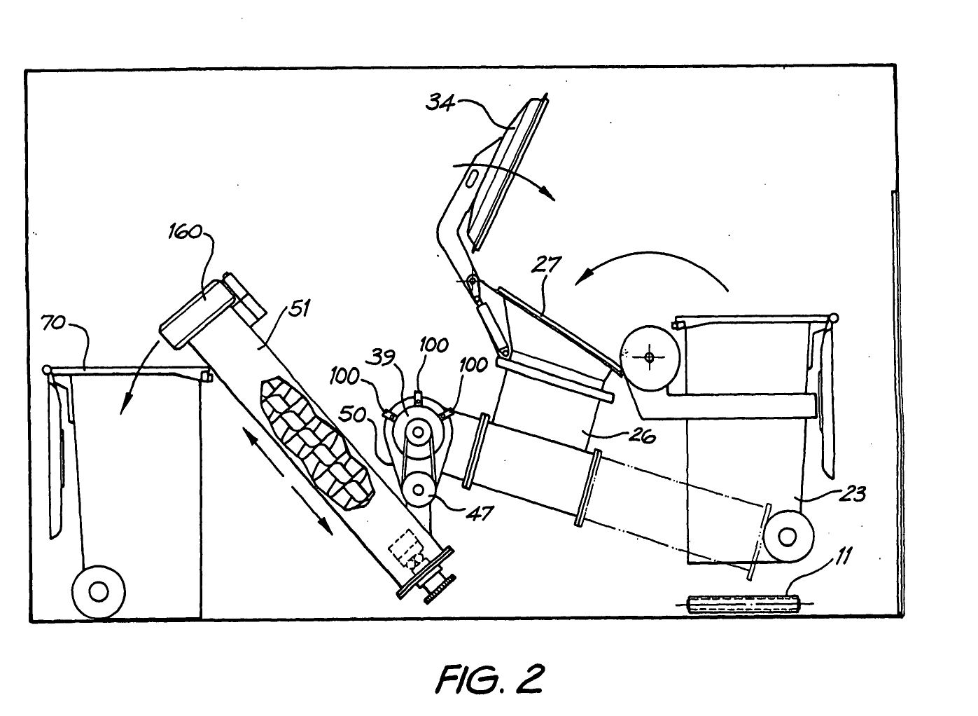

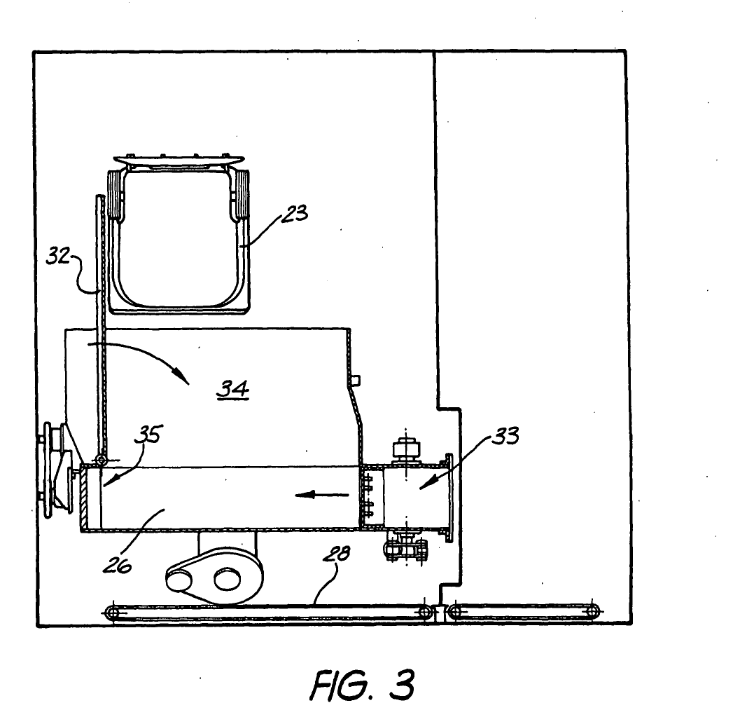

In the next phase of the waste treatment process, the bin 23 is inverted over an elongated loading hopper 26 as shown in FIGS. 2 and 3. The hopper 26 includes a funnel-like mouth 27. As shown in FIG. 2, the bin 23 is inverted over the hopper 26 and, while inverted, is shaken and transported along the hopper 26 by the conveyor 28. When the now empty bin 23 reaches the far end 29 of the hopper 26, it is restored to its original upright position on the conveyor 28 by a mechanism not shown. At this point, the bin may be conveyed into the bin wash module 30 through an internal door 31.

As shown in FIG. 3, waste which is in the hopper 26 is first contained by lowering a first containment door 32 over the hopper 26. The first containment door 32 acts as a barrier and facilitates the action of the scissor-activated waste feed transfer mechanism 33. After the first containment door 32 is in position, the second containment door 34 is closed (see FIG. 2). The second door 34 seals the contents of the hopper 26 from the environment. When the first door 32 is closed the feed transfer mechanism 33 is activated which has the effect of compressing and driving the waste towards the end wall 36 of the hopper 26 which has an opening 35 in the lower portion of end wall 36 which provides a passage between the hopper 26 and a ram-operated guillotine 37. A hydraulic ram could be used to drive the feed mechanism but in this instance the scissors feed is preferred.

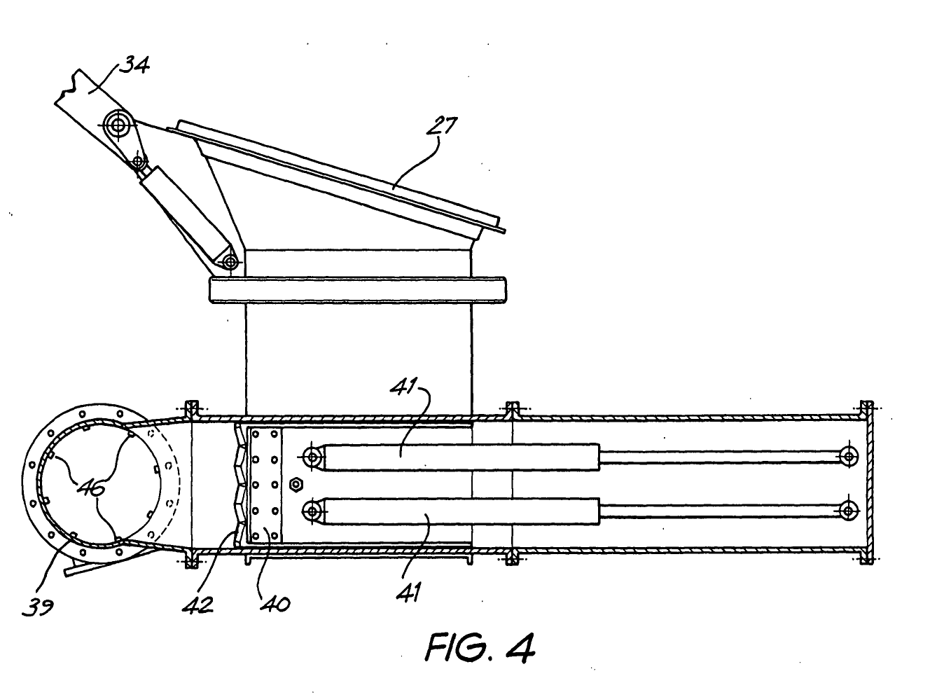

Compacted waste enters the guillotine chamber 38 from where it is urged into the first treatment chamber 39. The guillotine 37 is advanced and retracted by one or more hydraulic rams 41. The guillotine 37 has a compression and cutting head 40 which serves to discharge the contents of the guillotine chamber 38, shearing the waste as required. The working portion of the head 40 comprises a sharp serrated shearing edge 42 as shown in FIG. 4.

Once in the first treatment chamber 39, the waste material is advanced towards the first cutting mechanism 40 by the first auger 45 whilst steam is introduced by the steam inlet valves 100 as is described below. The first auger 45 is driven from the inlet end of the first treatment chamber 39 by a hydraulic motor 47. As shown in FIG. 4, the internal surface of the first treatment chamber 39 has rifling 46. There is a small gap between the outer periphery of the first helical auger 45 and the rifling 46. Waste which passes over the peripheral edge of the first auger 45 during motion of the auger is sheared between the auger edge and the rifling 46.

A cutting mechanism or head 48 defines the terminal end of the first waste treatment chamber 39. The cutting head 48 comprises a planetary gear box 60 and each planet gear within the gear box 60 has a stub axle 59 which carries a cutter 61. The cutters 61 have a generally cylindrical body 62. Each body 62 carries a number of cutting blades 63. The cutting blades 63 of conical shape extend from the base 64 of each cutter to a conical free end face 65.

In a preferred embodiment of the invention, the blades are oriented anti-sense by comparison to conventional cutter blades. That is, each cutting blade 63 curves from the free end 65 of the body 62 to the base 64 of the body 62 with the base end of the cutting blade leading the free end of the cutting blade so that rotation of the cutter 61 drives the edge of the blades 63 into the waste but urges the waste material in the chamber 39 away from the base 64 rather than towards the base 64. The anti-sense pitch of the cutter blades 63 tends to reduce the accumulation of waste material around the cutting head 48.

The stub axles 59 and hence the cutter 61 are equally radially spaced from the centre of the gear box 60 and are equally spaced from one another. The space interior to the plurality of cutters 61 is occupied by a gear-like or scalloped head 66. The head 66 comprises a generally cylindrical shape which fits closely within the arrangement of the cutters 61 and which is formed with a number of outwardly directed teeth 67 along its periphery. Waste is effectively sheared in the spaces between the cutter 61 and the head 66. The head 66 is carried on a stub axle 68 which extends from the gear box 60. The end of the stub axle 68 holds bearings which support the end of the first auger 45.

While the first auger 45 is running through its duty cycle of, in this instance, 42 seconds, with steam entering the chamber 39, the cutter head 48 is started and is rotated for 5 seconds in a first direction to advance the waste material towards the cutting head 48 and 5 seconds in a reverse direction and then 10 seconds forwards and 10 seconds reverse, changing direction in accordance with this time cycle or as required by the load sensors (not shown).

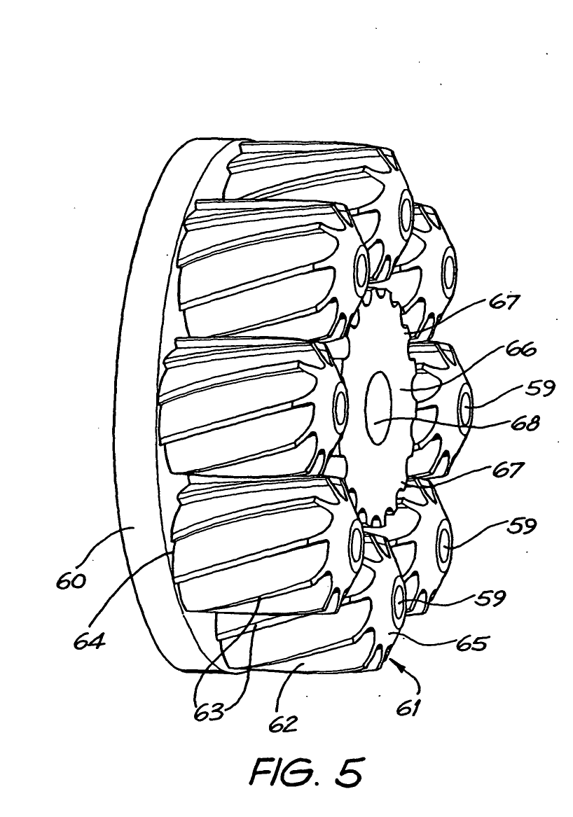

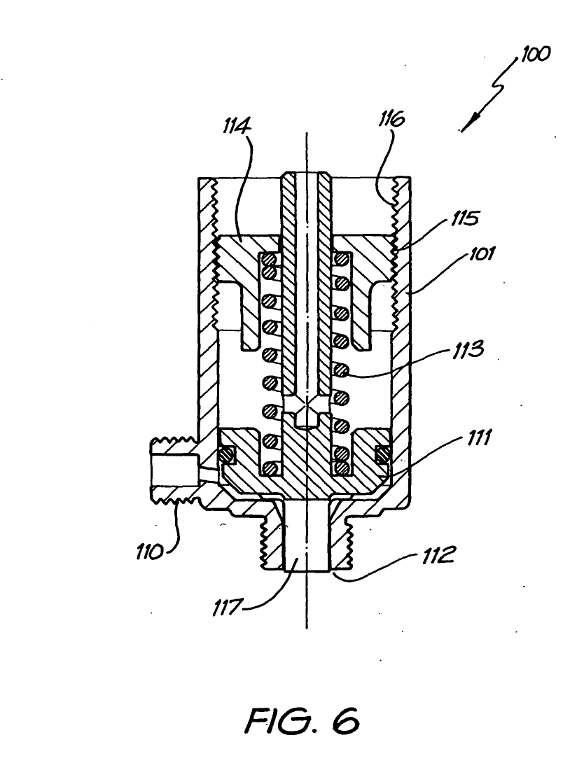

In this embodiment, steam is introduced into the first treatment chamber 39 during the operation of the cutting head 48 through self-cleaning steam valves 100 of the type depicted in FIG. 6. As shown, each steam valve 100 comprises a body 101 having a steam inlet 110. A reciprocating plunger 111 resides in the body 100 and is urged towards the steam outlet 112 by a compression spring 113. The degree of compression in the spring 113 is determined by the position of an adjustable back stop 114. The outer periphery 115 of the back stop 114 is threaded and these threads co-operate with internal threads 116 formed in the internal bore of the body 110. When the pressure of the steam entering the body 100 through the inlet 110 reaches a predetermined level, the plunger 111 is lifted against the spring bias. When the plunger 111 is lifted, the plunger tip 117 rises enough to allow steam to exit the outlet 112. When the steam pressure is relieved, the plunger 111 returns to its original position and the tip of the plunger 117 purges the outlet 112 of any obstructions or debris. The self cleaning valves 100 are distributed along the length and around the periphery of the first treatment chamber 39 (and, as will be discussed below, around the second treatment chamber).

Adjacent the first treatment chamber 39 is a second treatment chamber 51 which also has steam inlet valves 100 distributed along its length and around its outer surface as described above in relation to the first treatment chamber 39. At the end of the operation cycle of the first treatment chamber 39, a dividing gate 50 which separates the first treatment chamber 39 from the second treatment chamber 51 is opened. The dividing gate 50 comprises a reinforced door 120 which is rigidly connected to an actuating lever 121. The lever 121 is connected to a hydraulic actuator 122 which opens and closes the door 120. An outer portion 123 of the door 120 lies on the outside of the exterior surface 124 of the first treatment chamber 39. A second or inner part 125 of the door 120 has an arc-shaped interior surface which is designed to fit snugly within the opening 126 formed in the wall of the first treatment chamber 39. As shown in FIG. 7, an interior edge 127 of the second part 125 is bevelled so as to lie within the bevelled edge 128 of the discharge opening 126. This arrangement creates a strong gate structure which resists inadvertent opening and is, when closed, flush with the interior of the first treatment chamber 39.

A second helical auger 52 within the second treatment chamber 51 is activated 2 seconds before the dividing gate 50 is opened and then, in this instance, runs for an overall time period of approximately 120. The second auger 52 operates (with steam supplied into the second chamber 51) in the forward direction for 10 seconds or until the load sensor activates and changes its direction and reverses for 10 seconds or until the load sensor activates and changes its direction. At the end of the cycle period, the second auger 52 is operated in the forward direction for a period of time to purge the second chamber 51. At the end of the cycle period, the primary outlet gate mechanism 160 opens and remains open for a time period sufficient to allow the waste to be discharged into the discharge bin 70.

As shown in FIG. 9, the outlet gate mechanism 160 comprises an inner gate 161 and an outer gate 162. The inner gate 161 consists of a solid steel disk or plate 163 which is pivotally connected to the second waste treatment chamber 51. The connection between the plate 163 and the chamber 51 comprises a hinge 164 located above the second auger 52. The bottom edge of the disk 63 carries a reversed “J” shaped section 165. The section 165 engages the bottom of a terminal flange 166 of the second treatment chamber 51. This provides a positive mechanical engagement between the inner gate 161 and the chamber 51 when the inner gate 61 is closed.

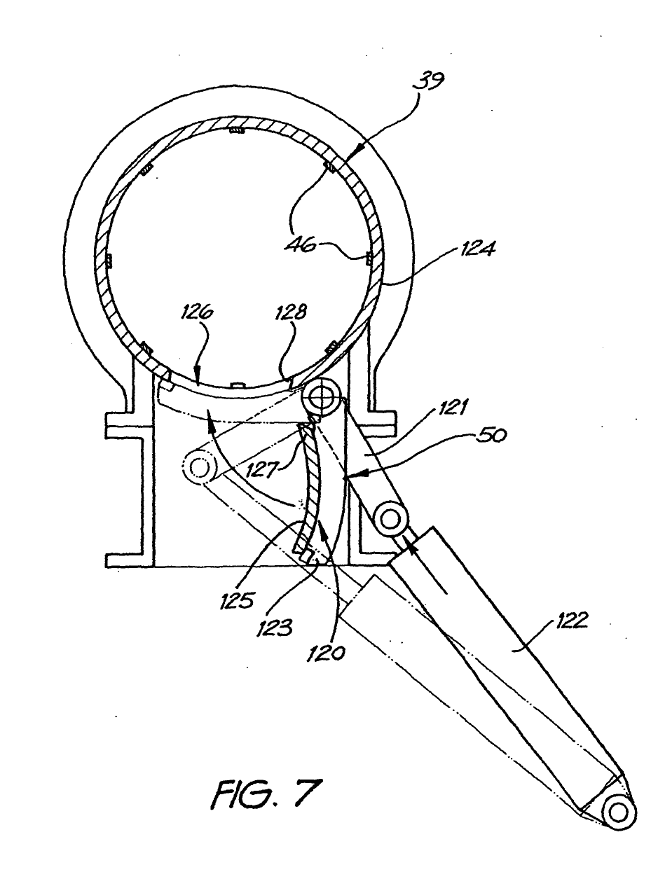

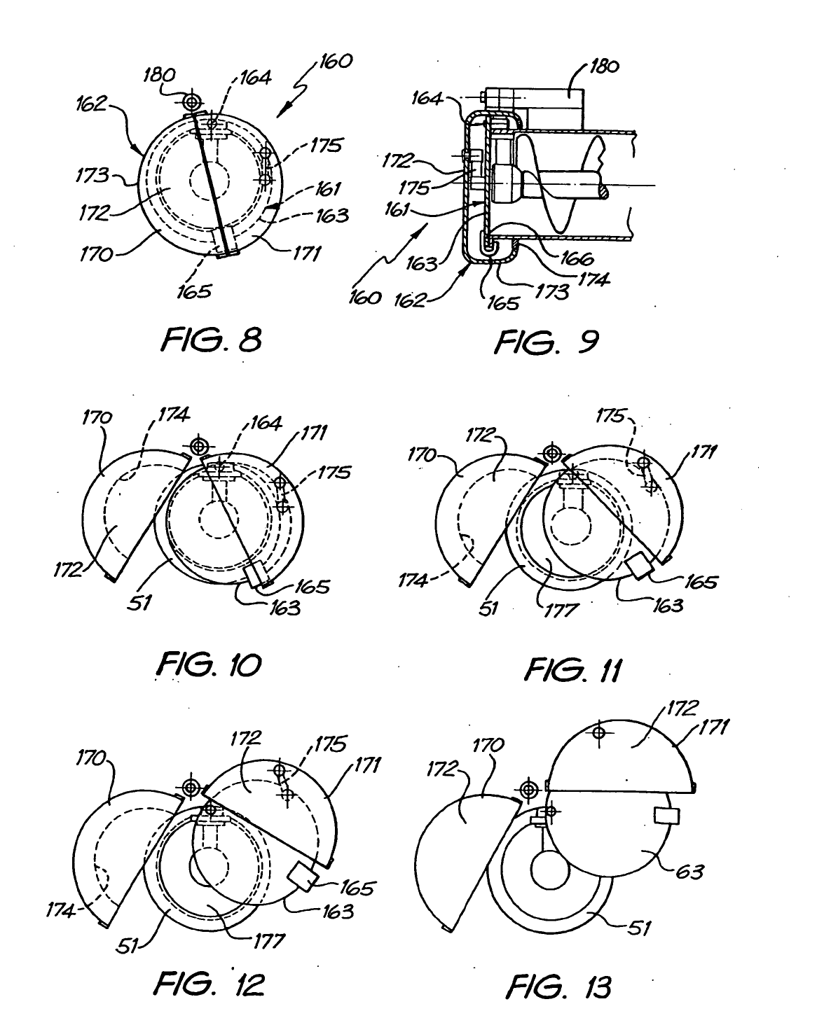

The opening and closing movement of the inner gate 161 is determined by the action of the outer gate 162. The outer gate 162 forms an outer covering and seal and as shown in FIG. 8 comprises two similar and co-operating half gates 170 and 171. Each half gate 170 and 171 further comprises a semi-circular front portion 172 and a semi-cylindrical side wall 173 (see FIG. 9) and a semi-circular sealing surface 174. Each sealing edge 174 is terminated with a section of “O” ring material to effect a seal between the outer gate 162 and the chamber 51. Similarly, the edges of the half gates 170 and 171 which meet together are also formed with grooves in which “O” ring sections are placed to effect a seal between the two half gates 170 and 171.

FIGS. 10 to 13 illustrate the sequence in which the inner gate 161 and the outer gate 162 are opened under the influence of a hydraulic actuator 180 mounted on the exterior of the second treatment chamber 51. In FIG. 8, the two half gates 170 and 171 are fully closed and held together to effect a seal between the two half gates 170 and 171 and between the outer gate 162 and the second treatment chamber 51. FIG. 10 illustrates the outer gate 162 as partially open. In this position, the inner gate 161 has been displaced slightly owing to the linkage 175 connected between the inner and outer gates 161 and 162. As shown in FIGS. 8 to 13, the link 175 extends between the outside surface of the inner gate 161 and the interior surface of the half gate 171. In this way, when the half gate 171 is opened, it lifts the inner gate 161 away from the opening 177 at the end of the second treatment chamber 51.

The inner gate 161 serves primarily as a mechanical barrier to the exit of material and also serves to wipe obstructions away from the opening 177 when the gates 161 and 162 are closed. The outer gate 162 serves the function of providing an effective steam seal between the interior of the second treatment chamber 51 and the environment.

The quantity of discharge material in the discharge bin is monitored and when the discharge bin 70 can accommodate only one more discharge load from the second treatment chamber 51, the treatment cycle is terminated.

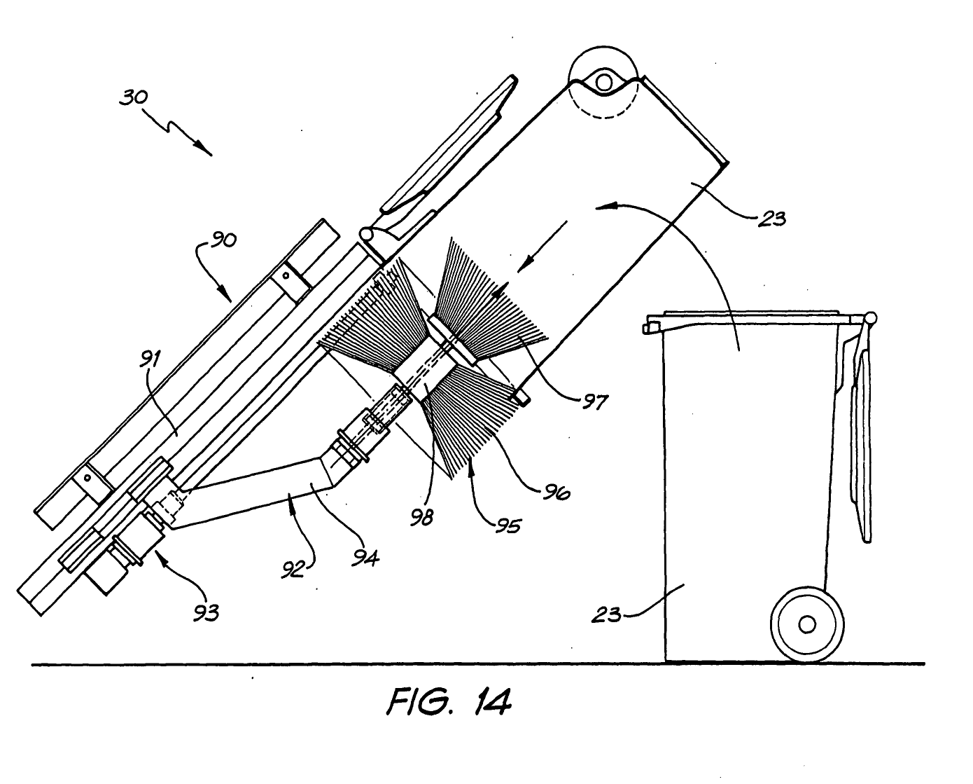

If the waste bin 23 is to be washed, it passes through the partition 31 between the cleaning chamber or module 20 and the washing chamber or module 30 and proceeds towards an automated cleaning mechanism 90 as shown in FIG. 14. The cleaning mechanism 90 includes a rail 91 along which travels a cleaning head 92. The cleaning head 92 includes a carriage 93 which couples the cleaning 92 head to the rail 91 and to which is attached an arm 94. The arm 94 creates a parallel offset between the rail 91 and the rotating brush 95 located at the end of arm 94. In this instance, the brush 95 comprises a body section having radially oriented bristles 96 and a cone shaped tuft of bristles 97. As shown in FIG. 14, the bin 23 is held in position and the brush 95 is advanced and retracted whilst rotating. A suitable mixture of water, detergent or solvents is provided under pressure to a dispensing head 98 of the brush 95. After the cleaning cycle, the bin 23 is returned to its upright position whereupon the exit door 98 (see FIG. 1) is opened so that the cleaned bin 23 may be discharged.

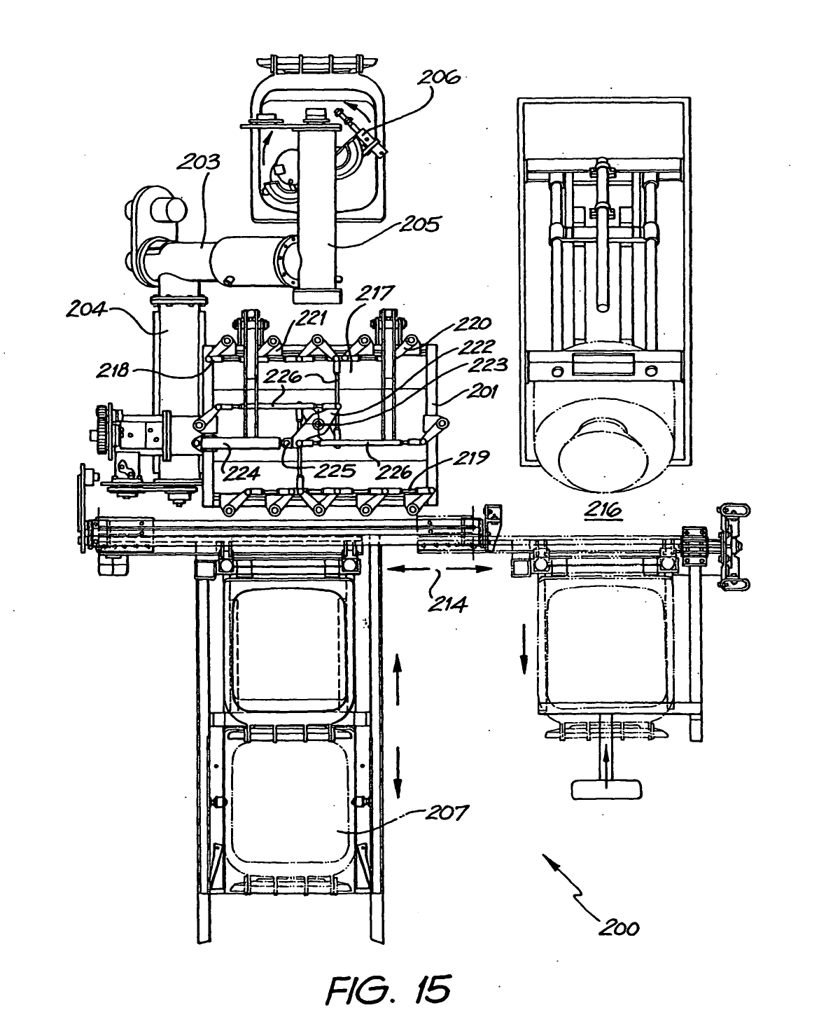

The second embodiment of the invention shown in FIGS. 15 to 19 is somewhat similar to the first embodiment in that the waste treatment apparatus 200 includes a loading hopper 201, a first treatment chamber 202 and a second treatment chamber 203. In addition, this embodiment of the invention includes a transfer auger 204 between the first treatment chamber 202 and the second treatment chamber 203 as well as a discharge auger 205 leading from the second treatment chamber to a discharge gate mechanism 206.

The bin 207 containing waste material to be treated enters the enclosure 208 and is transported by conveyor 209 towards the loading hopper 201. Adjacent the conveyor 209 there is a scissor-like elevating platform 210 which lifts the bin 207 to a pre-determined height where it is picked up by bin grabs 211 mounted on a carriage 212 coupled to a conveyor 213 that is adapted to move the bin 207 in the direction of arrows 214 as shown in FIG. 15.

As can be seen in FIG. 15, the bin 207 is initially located at the left hand side of the loading hopper 201 and is moved by the conveyor 213 to the right hand side of the hopper 201 and onwards to the cleaning station 216. Preferably, the bin at 207 is shaken as it is transported by the conveyor 213.

In this embodiment, the containment door 217 is locked closed by a plurality of lugs 218 that engage hollow bosses 219 mounted on the door 217. The lugs 218 are moved into and out of engagement with the bosses 219 by locking links 220 pivotally mounted on brackets 221 on the hopper 201. In the central portion of the door 217 there is an actuating arm 222 having a central pivotal axis 223. The arm 222 is connected to an operating hydraulic cylinder 224 by link 25 and by links 226 to the locking links 220.

As opposed to the first embodiment, this embodiment of the invention includes a shredding mechanism 230 at the outlet of the hopper 201 which discharges shredded waste material to the first treatment chamber 204.

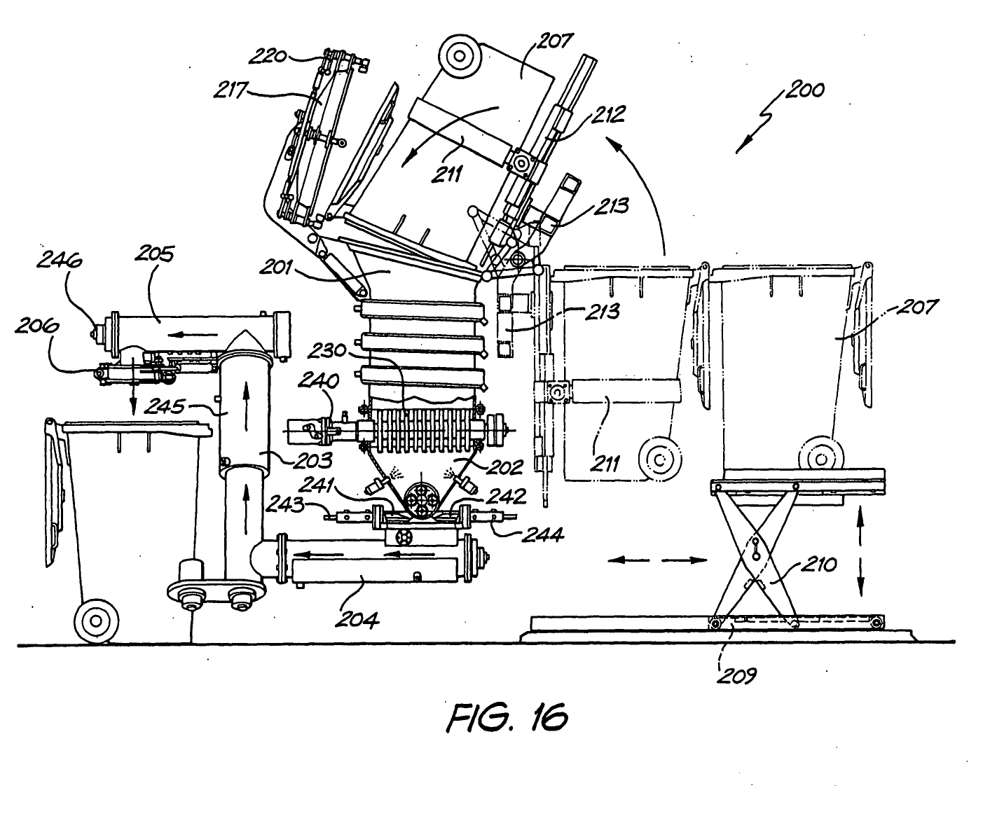

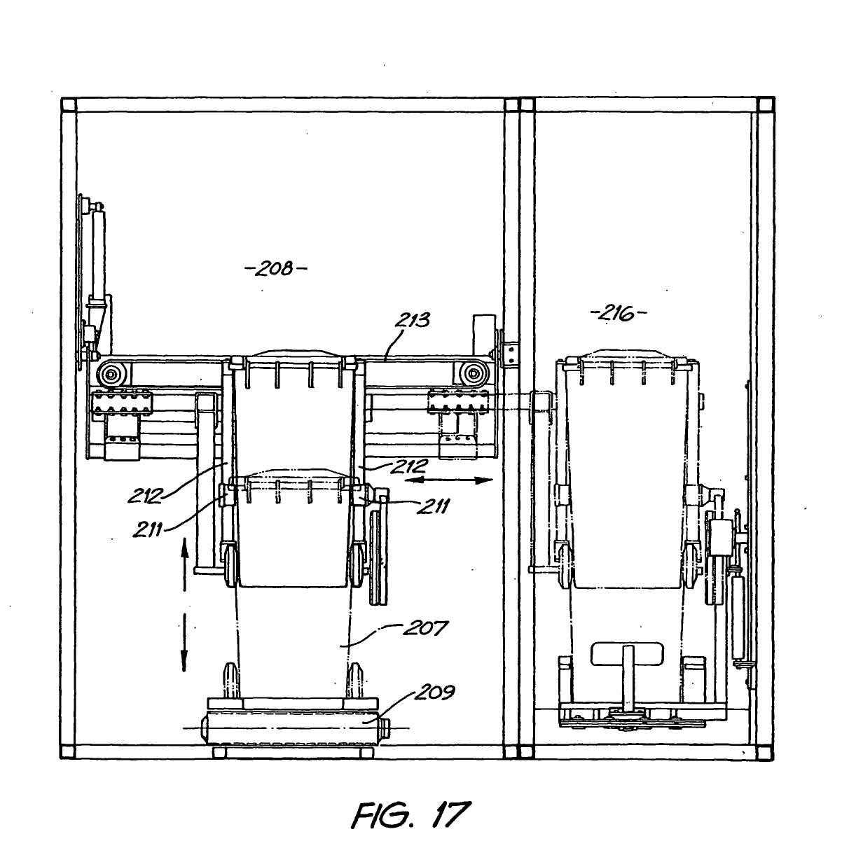

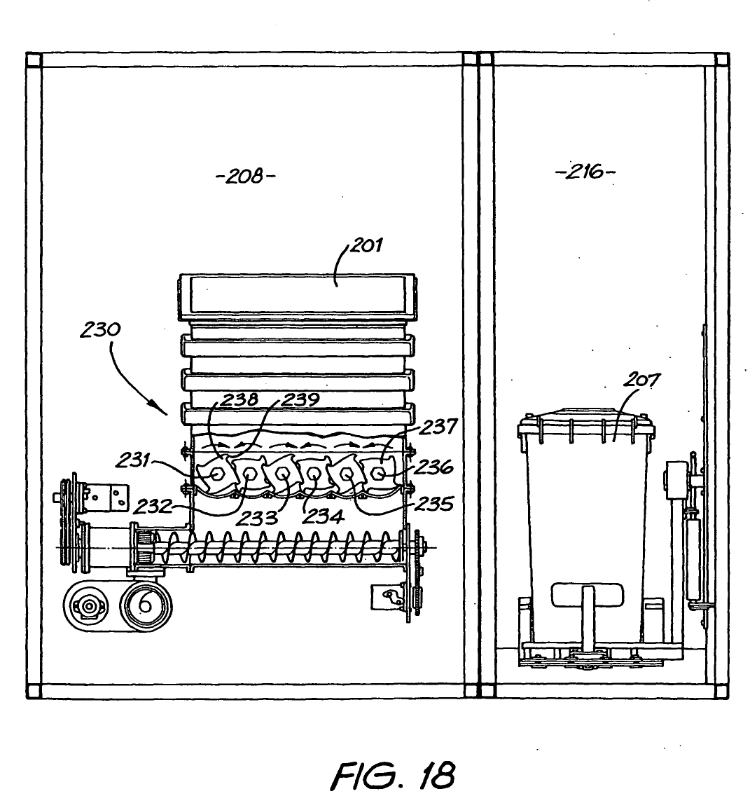

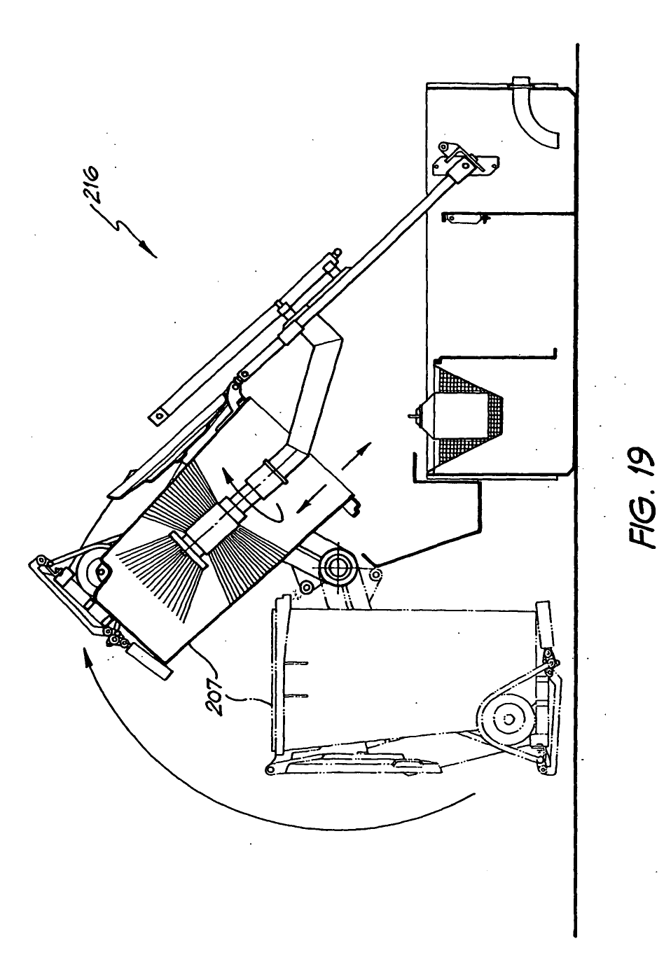

As shown in FIGS. 16 and 18, the shredder mechanism 230 comprises a plurality of synchronised rotating shafts 231 to 236 on which are rigidly mounted specially configured shredder blades 237. Each blade 237 comprises a number of equally spaced teeth 238, and this example, being four in number. The teeth 238 are slightly concaved below the cutting edges 239. The blades 237 arranged on a given shaft 231 to 236 are in alignment and those of one shaft are off set with respect to those of the adjacent shaft. As can be seen in FIG. 18, shafts 231, 233 and 235 rotate clockwise and the intervening shafts 232, 234 and 236 rotate anti-clockwise. Because of the counter rotation of adjacent shafts, the upper parts of the blades converge, so that the teeth 238 grip the waste material and pull it down into the shredder mechanism 230. The shafts 231 to 236 are synchronised with respect to one another by the drive mechanism 240.

The first treatment chamber 202 is similar to the first treatment chamber of the first embodiment of the invention except that it has a different discharge door 240 which consists of opposed half doors 241 and 242 operated by rams 243 and 244 respectively. The opposing portions of the half doors 241 and 242 are shaped to conform with the shape of the bottom of the first treatment chamber 202. A second cutting mechanism 250 in the first treatment chamber 202 is similar to that of the first embodiment and steam is introduced into the chambers 202 and 203 by valves 100 similar to those of the first embodiment.

At the top of the second treatment chamber 203 there is a steam jacket 245 for maintaining the desired temperature of the waste material as it is transported towards the discharge conveyor 205. At the end of the discharge conveyor 205 there is a gate mechanism 246 similar to that shown in the first embodiment. It will be appreciated that the construction of both embodiments of the invention is such that the interior of the treatment apparatus is securely sealed from the surroundings during operation of the apparatus.

1. Waste treatment apparatus comprising:
(i) a hopper having an inlet for receiving waste material and an outlet for discharging the waste material;
(ii) a first waste treatment chamber having an inlet in communication with the outlet of the hopper, and an outlet;
(iii) a first cutting mechanism operative to effect a first cutting treatment of the waste material as the waste material is discharged from the hopper to the first waste treatment chamber;
(iv) a second waste treatment chamber having an inlet in communication with the outlet of the first waste treatment chamber, and an outlet;
(v) a second cutting mechanism within the first waste treatment chamber operative to effect a second cutting treatment of the waste material before it is discharged to the second treatment chamber;
(vi) a gate mechanism operative to permit discharge of the treated waste material from the apparatus;
(vii) means for introducing steam into the first treatment chamber whilst the first cutting mechanism is in operation; and
(viii) means for introducing steam into the second treatment chamber whilst waste material is transported from the inlet of the second treatment chamber to the outlet of the second treatment chamber.

2. Apparatus according to claim 1 wherein the hopper is elongated and has an open top which is closed by a containment door and wherein the outlet is at one end of the elongated hopper.

3. Apparatus according to claim 2 and further including a waste feed transfer mechanism at the other end of the elongated hopper adapted to compress and feed the waste material towards the hopper outlet.

4. Apparatus according to claim 3 wherein the containment door is a first containment door and there is a second containment door overlying the primary door which seals the interior of the hopper from the environment.

5. Apparatus according to claim 4 wherein the first containment door is adapted to actuate the waste feed transfer mechanism.

6. Apparatus according to claim 1 wherein the first cutting mechanism comprises a reciprocating guillotine mounted within a guillotine chamber adjacent to the outlet of the elongated hopper.

7. Apparatus according to claim 6 wherein the guillotine includes a compression and cutting head which is adapted to discharge the waste material from the guillotine chamber cutting or shearing the waste in the guillotine chamber from the waste material in the hopper.

8. Apparatus according to claim 7 wherein the compression and cutting head includes a sharp serrated shearing edge.

9. Apparatus according to claim 1 and including an auger within the first waste treatment chamber.

10. Apparatus according to claim 9 wherein the first waste treatment chamber is circular in cross section and its internal surface is provided with rifling.

11. Apparatus according to claim 9 including drive means for rotating the auger and wherein the auger is rotated in a first direction to feed the waste material from the inlet of the first waste treatment chamber towards the first cutting mechanism and periodically reversed.

12. Apparatus according to claim 9 wherein the first cutting mechanism includes a planetary gear box having a plurality of planet gears, a stub axle projecting out of the gear box from each planet gear, and a generally cylindrical cutting head on each stub axle.

13. Apparatus according to claim 12 wherein each cutting head includes a body portion having a base adjacent the gear box and a free end face remote from the gear box, and a plurality of cutting blades spaced around the periphery of the body portion.

14. Apparatus according to claim 13 wherein each cutting blade curves from the free end to the base of the cutting head with the base end of the cutting blade leading the free end of the cutting blade when the cutting head is rotated.

15. Apparatus according to claim 14 wherein the free end of the cutting head has a conical surface.

16. Apparatus according to claim 12 wherein the stub axles are equally radially spaced from the centre of the planetary gear box and extending from the centre of the planetary gear box there is a central stub axle which carries a central generally cylindrical cutting head having a plurality of outwardly directed cutting teeth around its periphery.

17. Apparatus according to claim 9 wherein the auger is driven by an hydraulic motor mounted on the exterior of the first waste treatment chamber.

18. Apparatus according to claim 16 wherein the central cutting head has at its centre a bearing for the leading end of the auger in the first waste treatment chamber.

19. Apparatus according to claim 1 wherein the means for introducing steam comprises a plurality of steam inlet valves mounted on the first treatment chamber.

20. Apparatus according to claim 19 and including a plurality of steam inlet valves mounted on the second treatment chamber.

21. Apparatus according to claim 20 wherein each steam inlet valve comprises a body having a steam inlet adapted to be coupled to a suitable supply of steam, a steam chamber in the body, a steam outlet from the steam chamber leading to the interior of the treatment chamber and a spring biased reciprocating plunger in the steam chamber having a tip which is normally biased towards and to close the steam outlet, the arrangement being such that when the pressure in the chamber reaches a predetermined level, the plunger is moved away from the steam outlet so that the tip is lifted from the steam outlet to allow steam to flow into the treatment chamber.

22. Apparatus according to claim 10 wherein the outlet from the first treatment chamber is closed by a door pivotally mounted on the first treatment chamber adjacent to its outlet and which is pivoted between a first position in which the outlet is closed and a second position in which the outlet is open by a lever connected to an actuator.

23. Apparatus according to claim 22 wherein the inner face of the door is arcuately shaped to conform to the shape of the interior of the first waste treatment chamber.

24. Apparatus according to claim 1 wherein the second waste treatment chamber is circular in cross section and includes an auger within the chamber.

25. Apparatus according to claim 1 wherein the gate mechanism includes an inner gate and an outer gate and wherein the outer gate is opened and closed by an actuator and the inner gate is connected to the outer gate so that it is opened and closed by the movement of the outer gate.

26. Apparatus according to claim 25 wherein the inner gate is a circular solid plate hinged to the second treatment chamber and connected to the outer gate by a linkage.

27. Apparatus according to claim 25 wherein the outer gate consists of two similar and co-operating half gates, with each half gate comprising a straight edge facing the other half gate, a semi-circular front portion, a semi cylindrical side wall extending around the outer periphery of the semi-circular front portion and an inwardly directing sealing surface around the side wall adapted to seal against the outside of the second treatment chamber.

28. Apparatus according to claim 27 including seals between the straight portions of each half gate and between the sealing surfaces of the half gates and the second waste treatment chamber.

29. Apparatus according to claim 9 and further including an enclosure having a door through which a bin containing waste material may be introduced.

30. Apparatus according to claim 29 and further including a weighing station within the enclosure adjacent to the enclosure door.

31. Apparatus according to claim 29 and further including a conveyor upon which the bin is loaded and then moved along the hopper as its contents are discharged into the hopper.

32. Apparatus according to claim 31 and further including a bin discharge door at the end of the conveyor.

33. Apparatus according to claim 29 and further including a metal detector within the enclosure adjacent the entrance door to the enclosure.

34. Apparatus according to claim 29 and further including a bin washer in a separate housing within the enclosure.

35. Apparatus according to claim 34 wherein the bin washer includes a cleaning head comprising a carriage which travels along a fixed rail, an offset arm extending from the carriage and terminating in a brush and a dispensing head for dispensing a cleaning solution.

36. Apparatus according to claim 34 and further including a discharge door through which the cleaned bin may be discharged from the washer housing.

37. Apparatus according to claim 1 and further including a transfer auger between the first treatment chamber and the second treatment chamber.

38. Apparatus according to claim 1 and further including a discharge auger leading from the second treatment chamber to the discharge gate mechanism.

39. Apparatus according to claim 1 wherein the first cutting mechanism includes a plurality of rotating shafts on which are mounted shredder blades, the shredder blades being arranged on each shaft so as to be in register with the blades on adjacent shafts.

40. Apparatus according to claim 39 wherein each blade has a plurality of equally spaced teeth.

41. Apparatus according to claim 40 wherein each tooth has a concave cutaway portion beneath its cutting edge.

42. Apparatus according to claim 41 wherein each blade has four teeth.

43. Apparatus according to claim 39 wherein adjacent shafts are contra rotated and there is an even number of shafts with adjacent pairs of shafts being counter rotated in the sense that the top portion of the blades on each pair of shafts move towards one another so as to draw the waste material into the first cutting mechanism.

44. A gate mechanism operative to permit discharge of treated waste material from waste treatment apparatus comprising an inner gate and an outer gate and wherein the outer gate is opened and closed by an actuator and the inner gate is connected to the outer gate so that it is opened and closed by the movement of the outer gate.

45. A gate mechanism according to claim 44 wherein the inner gate is a circular solid plate hinged to the second treatment chamber and connected to the outer gate by a linkage.

46. A gate mechanism according to claim 44 wherein the outer gate consists of two similar and co-operating half gates, with each half gate comprising a straight edge facing the other half gate, a semi-circular front portion, a semi cylindrical side wall extending around the outer periphery of the semi-circular front portion and an inwardly directing sealing surface around the side wall adapted to seal against the outside of the second treatment chamber.

47. A gate mechanism according to claim 46 including seals between the straight portions of each half gate and between the sealing surfaces of the half gates and the second waste treatment chamber.

48. A cutting mechanism for waste treatment apparatus comprising a pair of rotating shafts on which are mounted shredder blades, the shredder blades being arranged on each shaft so as to be in register with the blades on adjacent shafts.

49. A cutting mechanism according to claim 40 wherein each blade has a plurality of equally spaced teeth.

50. A cutting mechanism according to claim 41 wherein each tooth has a concave cutaway portion beneath its cutting edge.

51. A cutting mechanism according to claim 42 wherein each blade has four teeth.

52. A cutting mechanism according to claim 43 wherein adjacent shafts are contra rotated and there is an even number of shafts with adjacent pairs of shafts being counter rotated in the sense that the top portion of the blades on each pair of shafts move towards one another so as to draw the waste material into the first cutting mechanism.
